(19) United States
(12) Patent Application Publication
(10) Pub. No.: US 2009/0046201 A1
(43) Pub. Date: Feb. 19, 2009

(54) HOLDING APPARATUS FOR A CAMERA LENS

(75) Inventors: William C. Kastilahn, Evanston, IL (US); Michael Gore, Spring Grove, IL (US)

Correspondence Address: SACHNOFF & WEAVER, LTD., 10 SOUTH WACKER DRIVE, CHICAGO, IL, 60606-7507, US

(73) Assignee: ShopperTrak RCT Corporation, Chicago, IL (US)

(21) Appl. No.: 11/838,644

(22) Filed: Aug. 14, 2007

(51) Int. Cl. H04N 5/225

(52) U.S. Cl. 348/375

(57) ABSTRACT

An apparatus for maintaining registration of a lens assembly in a consistent position over a sensor by positioning the sensor adjacent a sensor mount instead of a housing encompassing the lens assembly and sensor. The apparatus comprises a lens assembly having at least one predetermined focal center, and a lens barrel for holding the lens assembly. A holder adjustably supports the lens barrel, the holder having a base and a cylinder, with the lens barrel adjustably mounted in the cylinder. The base of the holder is attached to a support, such as a circuit board, whereby the focal center of the lens assembly is held in a predetermined aligned position relative to the sensor. In an embodiment, wall surfaces defining an opening in the base of the holder firmly engage the sidewalls of a ceramic sensor mount.

### FIELD

The present invention generally relates to the field of photographic equipment and specifically to a lens holding assembly used in digital photographic equipment. More specifically, the present invention relates to a holding apparatus for maintaining the registration of a lens assembly relative to a sensor by supporting the apparatus relative to a mount for the sensor, rather than supporting the apparatus from a housing for the lens assembly and sensor.

### BACKGROUND

Achieving high quality optical performance for photographic equipment requires a lens holding assembly that can support the lens barrel in a stable position while maintaining alignment of the lens with a photosensitive sensor chip. The structure of a prior lens holding assembly is disclosed previously, for example, in U.S. Pat. No. 5,576,895. U.S. Pat. No. 5,576,895 is directed to a lens barrel holding apparatus comprising a lens barrel having a flange portion formed along the circumferential direction of the outer peripheral portion of the lens barrel, and a lens bed having a cylindrical recess of a diameter larger than the diameter of the flange portion. The recess and the flange portion are coupled together by a plurality of bar-like supporting members. Additional supporting members are added to the upper part of the flange portion along the circumferential direction of the flange portion and are coupled to the flange portion and to the lens barrel holding bed.

Traditional lens holding assemblies, such as the one disclosed in the prior art described above, require special design of the lens barrel and supporting members, are usually difficult to assemble or dissemble, and may not provide for maintaining critical alignment of the lenses with a sensor chip placed on a printed circuit board assembly. Further, in many photographic structures, the lens assembly is mounted to a housing surrounding the sensor structure, and the lenses are not maintained in a fixed position relative to the sensor or sensor mounting assembly.

Thus, it is a primary objective of the present invention to provide a lens holding assembly that can stably hold a lens barrel while maintaining alignment between the focal center of the lens system and a sensor chip mounted on a printed circuit board assembly or other chip support surface.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings, of which:

FIG. 1 is a front perspective view of an embodiment of a lens holding assembly in accordance with the present invention;

FIG. 2 is a bottom plan view of the lens holding assembly shown in FIG. 1;

FIG. 3 is a top plan view of the lens holding assembly shown in FIG. 1; and

FIG. 4 is a side sectional view of the lens holding assembly taken along line 4-4 in FIG. 1.

### DETAILED DESCRIPTION

The present invention provides an apparatus for holding lenses positioned over sensor chips in such a manner that the lenses are automatically registered to the sensor position and held fixed by special design of the lens holders.

In the description that follows, the lens holding assembly is explained in further detail.

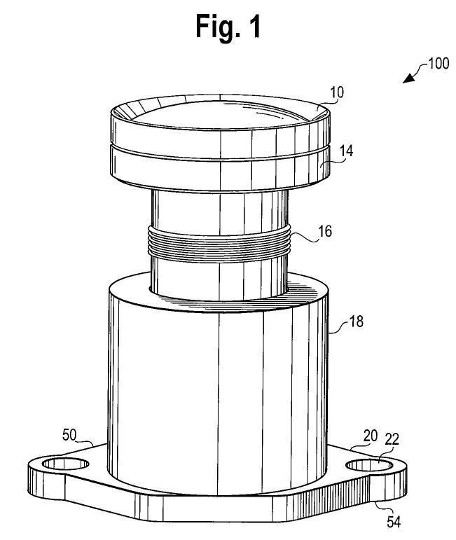

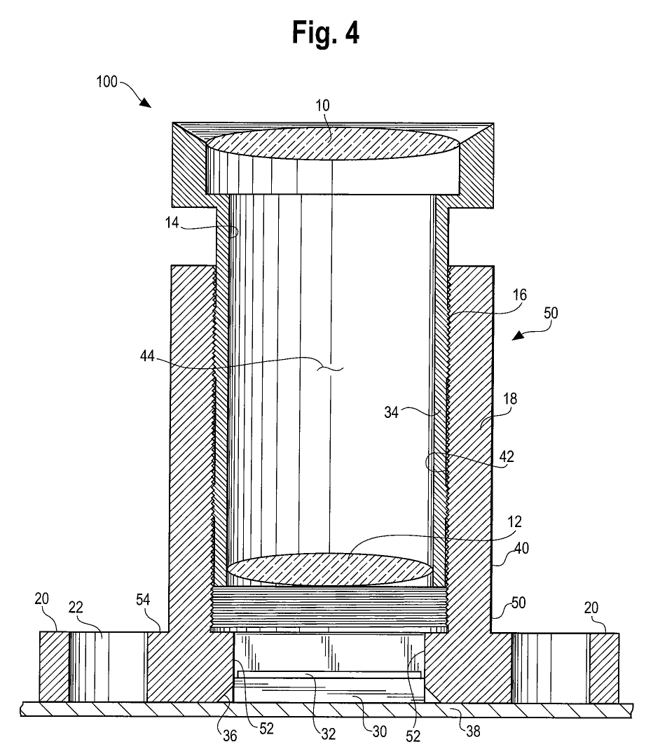

FIG. 1 is a front perspective view showing a lens holding assembly 100 in an embodiment of the present invention. As seen in FIGS. 1 and 4, the lens holding assembly 100 comprises a lens barrel 14 having a first lens 10 and a second lens 12. The two lenses 10, 12 are positioned such that they share a common optical axis that is the same as the center axis of the barrel 14. However, the number of lenses in the lens barrel 14 should not be considered limited to what has been shown in the drawings, and any number of lenses compatible with the present invention may be utilized.

The lens barrel 14 is adapted to be moveably inserted into a lens holder assembly 50, including a hollow cylinder 18. As seen in FIG. 4, a support surface, such as a printed circuit board assembly 38 is provided, with at least one sensor chip 32 mounted on the printed circuit board assembly 38, such that sensor chip 32 is disposed adjacent the underside of lens holder assembly 50.

As seen in FIGS. 1 and 4, the lens barrel 14 holds the projection optical system comprising lenses 10 and 12. The lens barrel 14 is also provided with an exterior threaded surface portion 16 on the exterior surface of the lens barrel 14 (FIG. 1). The exterior thread member 16 of the lens barrel 14 is adapted to mesh with a matching thread member on the interior surface of the cylinder 18 for removably and adjustably attaching the lens barrel 14 to the lens holder 50, as will be described.

Referring to FIG. 4, the printed circuit board assembly 38 is a thin plate on which chips, such as the sensor chip 32, and other electronic components, are placed. The sensor chip 32 comprises a video sensor which receives photons through the lenses 10, 12 and forms light images when electrons in the video sensor react to the photons. The sensor chip 32 then converts the light images to digital signals through which digital image frames comprising pixels are generated. Examples of video sensors used in the present invention include CMOS (Complementary Metal-Oxide-Semiconductor) sensors and/or CCD (Charge-Coupled Device) sensors. However, the types of video sensors mentioned should not be considered limiting, and any video sensor compatible with the present invention may be utilized.

As seen in FIG. 4, in an embodiment, the sensor chip 32 is provided with an underlying ceramic mount or base 30 slightly larger in size then the chip. The sensor chip is fixed on the printed circuit board assembly 38 by attaching the ceramic base 30 to one surface of the printed circuit board assembly 38.

As seen in FIGS. 1-4, the lens holder 50 comprises a flat base 54 and the hollow cylinder 18 orthogonally extends from the base 54. The cylinder 18 comprises a hollow interior 44 allowing light to pass through from lens 10 to lens 12. Cylinder 18 also comprises an interior wall 42, and an exterior wall 40. The interior wall 42 is provided with an interior thread member 34 (FIG. 4) on the surface, where threads of the interior thread member 34 mesh with threads of the exterior threads 16 of the lens barrel 14, allowing the lens barrel 14 to be removably and adjustably attached to the lens holder 50 when the lens holder assembly 100 is assembled for use.

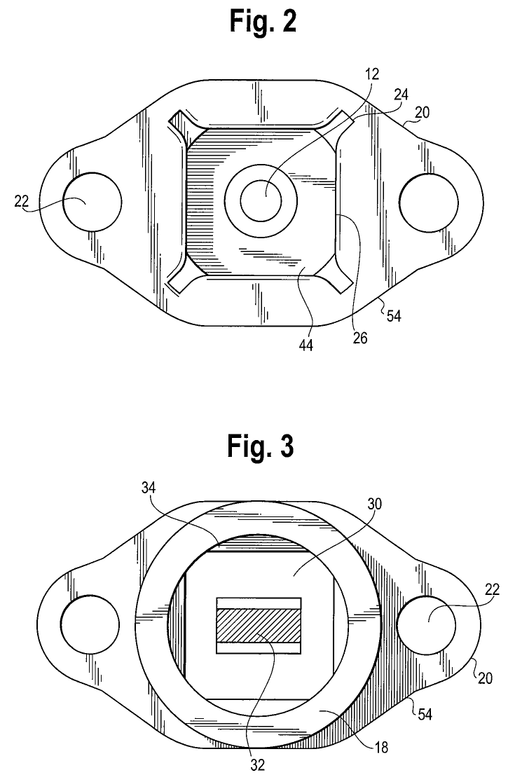

As seen in FIGS. 2 and 4, the base 54 comprises a bottom opening 48 in the center, and two flange portions 20 at opposing sides. Each flange portion 20 is provided with an aperture 22 to receive bolts or other suitable fasteners through the apertures to firmly attach the lens holder assembly 50 on the printed circuit board assembly 38. In an embodiment, bolts are fastened through the apertures 20 in the base 54 and corresponding apertures in the printed circuit board assembly 38 through mechanisms well known in the art, such as washers and nuts, and the like.

To maintain precise alignment of the focal center of the sensor chip 32 with the focal centers of the lenses 10 and 12, the present invention provides a unique construction for the bottom opening 48 of the base 54. The base 20, as seen in FIGS. 2 and 4, has a lead-in surface 36 on the bottom portion of each vertical wall 52 of the bottom opening 48, where in the illustrated embodiment, each lead-in surface 36 is at a forty-five degree angle from the upper portion of the vertical wall 52 of the bottom opening 48 (FIG. 4). The lead-in surfaces 36 allow the vertical walls 52 of the bottom opening 48 to readily slide over the outer vertical edges of the ceramic base 30 when inserting the lens holding assembly over the chip 32 and ceramic base 30, by creating a pressure fit between the walls 52 and the vertical edges of the ceramic base 30. When the lens holder assembly 100 is being assembled, the base 54 will snugly fit around the ceramic base 30 on the printed circuit board assembly 38, and remain securely locked in position adjacent sensor chip 32. This structure ensures that the lenses 10, 12 will always be in a constant and fixed position relative to the sensor chip 32 attached to the electrical circuit board 38.

Since the bottom opening 48 is adapted to firmly and slidably engage the sides of the ceramic base 30 when assembled, the bottom opening 48 of the lens holder 50 preferably takes the shape of the ceramic base 30. In the illustrated embodiment of FIG. 2, the ceramic base 30 and the bottom opening 48 are both rectangular. However, such design should not be considered limiting and other suitable shapes can be adopted for the bottom opening 48 and the ceramic base 30.

As seen in FIG. 2, in an embodiment of the invention, the four corners of the bottom opening 48 have circular patterns 24, which provide clearance near the corners of the ceramic base 30 to prevent cracking of the ceramic base 30 at the corners when the lens holder assembly 50 is being inserted over sensor chip 32 and ceramic base 30.

The lens holder 50 of the present invention is preferably constructed from a resistant, light, and durable material such as ABS (acrylonitrile butadiene styrene) plastic. However, the choice of material should not be considered limited to what has been described in the invention and other materials with similar properties are also within the scope of this invention.

In view of the many possible embodiments to which the principles of this patent may be applied, it should be recognized that the embodiments described herein with respect to the drawing figures are meant to be illustrative only and should not be taken as limiting the scope of the patent claims. Therefore, the invention as described herein contemplates all such embodiments as may come within the scope of the following claims and equivalents thereof.

What is claimed is:

1. An apparatus for holding a lens assembly in a consistent position adjacent a sensor, the sensor mounted on a support and the lens assembly having at least one predetermined focal center, the apparatus comprising:
a lens barrel adapted to hold the lens assembly;
a holder adapted to adjustably support the lens barrel, the holder comprising a base and a cylinder, the cylinder orthogonally extending from said base, said base adapted to be fixedly attached to said support, said at least one focal center of said lens assembly being held in a predetermined aligned position relative to said sensor.

2. The apparatus of claim 1 wherein said lens barrel includes a threaded exterior surface and said cylinder includes a threaded interior surface, said threaded exterior surface of said lens barrel meshing with said threaded interior surface of said cylinder.

3. The apparatus of claim 1 wherein said support is a circuit board.

4. The apparatus of claim 1 wherein the sensor is a video sensor.

5. The apparatus of claim 4 wherein said video sensor is selected from the group consisting of a Complementary Metal-Oxide-Semiconductor and a Charged-Coupled Device.

6. The apparatus of claim 1, wherein the lens assembly comprises two lenses mounted in said lens barrel.

7. The apparatus of claim 1 wherein an additional lens assembly holder comprising a base and a cylinder is adapted to be mounted to the support over an additional sensor, with the focal center of each lens assembly mounted in each holder being held in a predetermined aligned position relative to a respective sensor.

8. The apparatus of claim 1, wherein said base includes a light passage opening in the center of the base, and two flange portions on opposing sides adjacent the center of the base.

9. The apparatus of claim 8, wherein walls in said base form said opening in said base, said walls having lead-in surfaces in portions of said walls.

10. The apparatus of claim 9 wherein said lead-in surfaces are beveled at a forty-five degree angle from the surface of said walls.

11. The apparatus of claim 4, wherein corners of said walls of said opening are each provided with carved-out positions.

12. The apparatus of claim 11 wherein said carved-out portions are circular in cross section.

13. An apparatus for holding a lens assembly in a consistent position adjacent a sensor, the lens assembly having at least one predetermined focal center, comprising:
a support surface,
a sensor mount attached to said support surface, said sensor mount having side walls extending away from said support surface;
the sensor mounted to said sensor mount;
a lens barrel adapted to hold said lens assembly;
a holder adapted to adjustably support the lens barrel, the holder comprising a base and a cylinder, the cylinder orthogonally extending from the base, an opening extending through the base, said opening in said base defined by wall surfaces extending away from said support surface;
the base adapted to be attached to said support surface;
said wall surfaces of said base snugly engaging said side walls of said sensor mount when said base is attached to said support surface;
said at least one predetermined focal center of said lens assembly held in a predetermined aligned position relative to said sensor.

14. The apparatus of claim 13, wherein the sensor mount is made of a ceramic material.

15. The apparatus of claim 13 wherein said lens assembly comprises two lenses, each lens having the same focal center.

16. The apparatus of claim 13 wherein said lens barrel includes a threaded exterior surface and said cylinder comprises a threaded interior surface, said threaded exterior surface of said lens barrel meshing with said threaded interior surface of said cylinder.

17. The apparatus of claim 13 wherein said wall surfaces of said base defining said opening have lead-in surfaces in portions of said wall surfaces.

18. The apparatus of claim 13, wherein said sensor comprises a sensor chip attached to said sensor mount.

19. The apparatus of claim 13, wherein said wall surfaces of said base are adapted to firmly engage said sidewalls of said sensor mount and retain the lens assembly in a predetermined fixed position relative to said sensor as said wall surfaces of said base create a pressure fit with said side walls of said sensor mount.

20. The apparatus of claim 17 wherein said lead-in surfaces assist the wall surfaces of said base to advance along said side walls of said sensor mount upon placement of said base adjacent said sensor mount.
